(19) United States
(12) Patent Application Publication
(10) Pub. No.: US 2018/0096431 A1
(43) Pub. Date: Apr. 5, 2018

(54) Geographical Location Recommendation System

(71) Applicant: Aiooki Limited, Grand Cayman (KY)

(72) Inventors: Lam Sun, Foster City, CA (US); Boxiong Ding, San Jose, CA (US); Kuan-Cheng Lai, Santa Clara, CA (US)

(21) Appl. No.: 15/602,121

(22) Filed: May 23, 2017

Related U.S. Application Data
(60) Provisional application No. 62/404,714, filed on Oct. 5, 2016.

(51) Int. Cl. G06Q 40/06; G06Q 50/16; G06F 17/30

(52) U.S. Cl. CPC G06Q 40/06; G06Q 50/01; G06F 17/30241; G06Q 50/165

(57) ABSTRACT

Some embodiments provide a recommender system configured to recommend a geographical location to a user is provided. The recommender system may be configured to process unstructured data from various data sources such as social media, planning documents, news media, and/or any other type data sources that may provide certain information, regarding a project. In some exemplary implementations, text mining techniques are configured into the recommender system to process the unstructured data from those data sources and to extract various phrases and/or sentences regarding various geographical locations. One or more rules and/or criteria can be used by the recommender system to reveal one or more geographical locations for recommendation to a user based on the processed unstructured data

### CROSS-REFERENCE TO RELATED APPLICATIONS

The present application claims priority to U.S. Provisional Patent Application No. 62/404,714, filed on Oct. 5, 2016 and entitled “ENHANCED USER MATCHING, RECOMMENDATION AND PREDICATION SYSTEMS”, the disclosures of which is hereby incorporated by reference in their entireties for all purposes.

### BACKGROUND OF THE INVENTION

The disclosure relates to user matching and generating recommendation for users using a computer system.

User matching is generally known in the art. Existing user matching technologies typically match users based on their preferences or certain user characteristics. For example, two users may be matched simply based on their geographical locations. Under the existing user matching technologies, the user matching may be refined until an acceptable result is obtained. For example, the conventional matching technologies may first start with a big group of users that can be matched based on their generally geographical regions (e.g., their current countries), and fine-tuned to match their finer locations as desired (e.g., their current cities).

Recommendation systems are generally known in the art. Existing recommendation systems typically recommend an entity (e.g., a website) to a user based on a relationship between the recommended entity and the user's interest. For example, some of the existing recommendation systems are configured to collect data regarding user browsing activities and analyze such data to learn the user's interest. These systems are also configured to determine a likelihood the user will visit the website based on the learned user interest and select a website for recommendation to the user based on the determined likelihood the user will visit the website.

Bidding systems are generally in the art. Existing bidding systems are typically configured to receive user bids for a certain item. A given user bid that is received by the existing bidding systems typically a user determined price and an identification of the given item. The existing bidding systems are typically configured to compare all received user bids to determine a winning bid.

### BRIEF SUMMARY OF THE INVENTION

Some embodiments provide a recommender system configured to recommend a geographical location to a user is provided. The recommender system may be configured to process unstructured data from various data sources such as social media, planning documents, news media, and/or any other type data sources that may provide certain information, regarding a project. In some exemplary implementations, text mining techniques are configured into the recommender system to process the unstructured data from those data sources and to extract various phrases and/or sentences regarding various geographical locations. One or more rules and/or criteria can be used by the recommender system to reveal one or more geographical locations for recommendation to a user based on the processed unstructured data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

FIG. 1 conceptually illustrates generating a recommendation to user that includes a geolocation based on data provided by one or more data sources in accordance with the disclosure.

FIG. 2 illustrates an exemplary recommendation system for implementing the geolocation recommendation in accordance with the disclosure

FIG. 3 illustrates an exemplary method for recommending one or more geolocations to a given user in accordance with the disclosure.

FIG. 4 is a block diagram of computer system that can be used to implement various embodiments described and illustrated herein.

### DETAILED DESCRIPTION OF THE INVENTION

Embodiments can provide a recommendation system configured to generate information regarding a geographical location—geolocation for recommendation to a user. For achieving this, the recommendation system can be configured to collect unstructured data about the geolocation, e.g., text data about the geolocation from one or more data sources. For example, the unstructured data can include information regarding one or more projects planned in the geolocation. In some embodiments, the unstructured data obtained by the recommendation system can include information regarding more than one geolocation. In those embodiments, the unstructured data can be processed by the recommendation system to mine specific information related to a particular geolocation. For example, when the unstructured data comprises information regarding projects at different geolocations, the recommendation system can identify, from the unstructured data, one or more project effects to each of the one or more geolocations. The one or more geolocations can be presented to a user for suggesting one or more locations for the user to look for investment opportunities (e.g., real-estate investment opportunities) by virtue of the project effects in the one or more geolocations satisfy one or more predetermined criteria.

The data sources for the above-mentioned unstructured data may vary depending on different applications. Examples of the data sources may include: social media, city planning documents, corporate announcements or documents, and/or any other sources that may provide unstructured data regarding a geolocation. The social media sources may include websites like Facebook, Instagram, Sina Blog, Big Pocket, various online forums, and/or any other social media outlet. For example, Facebook postings by users within a geographical location may be monitored by the recommendation system such that when a user posts comments regarding a project within a particular geographical location or particular geolocations, the comments can be automatically obtained by the recommendation system. In exemplary implementations, various keywords regarding a project may be monitored on the social media outlets. The keywords may indicate various projects, projects, and/or planning identifications, relocation plans, employment opportunities and/or any other aspects regarding the projects within one or more geographical locations.

The city planning documents may be obtained by the recommendation system from publicly accessible websites such as websites run by a local government, county, municipality, and/or any other websites that may provide city planning documents for public access. In some embodiments, the city planning documents may be obtained by the recommendation system from privately accessible websites such as websites run by a consulting firm, a project company, an agency, and/or any other websites that may provide city planning documents for private access. Those websites may be monitored by the recommendation system and whenever a document is available for access on those websites, the document may be automatically obtained—e.g. downloaded by the recommendation system. The recommendation system may be configured to process the document and determine whether there is information regarding planned project within a particular geolocation. For example, the information in the city planning documents may indicate the location, the projects city is planning, and the status of those projects. Similarly, planning documents and/or announcements by corporations within the geographical location can be monitored and obtained to determine whether there is information regarding project planned by the corporation within the geographical location. For obtaining such corporate documents, websites of corporates within the geographical location can be monitored by the recommendation system. For example, the information in the corporation document may reveal what the new expansion is upcoming for the corporation, and the nature of the expansion: new office, new manufacture facilities, number of jobs and type of jobs that will be affected.

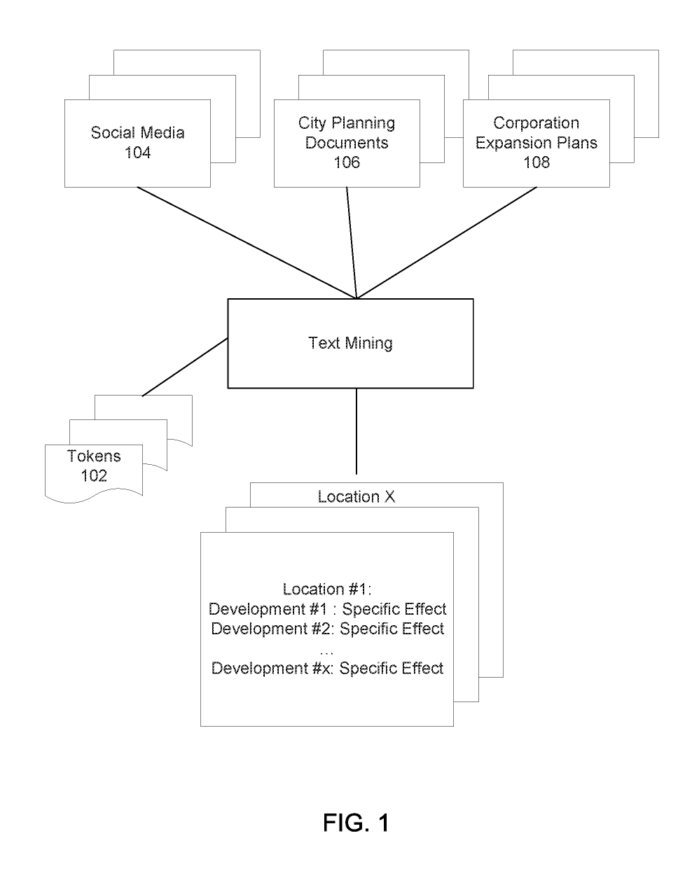

After various data as described above is obtained by the recommendation system, the recommendation system may be configured to process the data to identify one or more geolocations for recommendation to user. The processing may include text mining. This is illustrated in FIG. 1. In some exemplary implementations, as shown, the text mining performed by the recommendation system may involve using one or more predefined tokens 102 as shown in FIG. 1. The predefined tokens 102 may include keywords regarding one or more projects or planning within one or more geographical locations. Examples of the keywords may include the name of a particular geolocation (e.g., the city of San Diego, the city of New Port beach), “year”, “start date”, “job created”, “investment”, “money invested” and/or any other keywords. Those keywords or tokens can aid the text mining performed by the recommendation system to determine information relevant to the projects and/or planning within the one or more geographical locations.

Tokens 102 can be used in the text mining process to extract relevant information from the social media 104, planning documents 106, corporation documents 108 as described above. For example, effects regarding a particular project within a particular geographical location can be determined by the text mining process. For example, project #1 by company 1 will have $10 million investment in location #1 for facilities, may create 500 jobs and so on. As another example, planning by the city in location #1 will build a shopping mall, may create 250 jobs, company #2 may open a direct store in this shopping mall and so on. Such information may reveal the locations of investment/project interest, activities, the parties that are involved for the projects or planning within the geolocation.

After the project information is obtained through the text mining, the information can be organized according to projects. For example, as shown in FIG. 1, within geographical location #1, there may be 7 projects that will take place within next year. The effects of those projects can be extracted from the obtained project information and can be presented to a given user in an ordered list. For example, projects with most recent start date can be placed first on the list and projects with later start date can be placed later on the list.

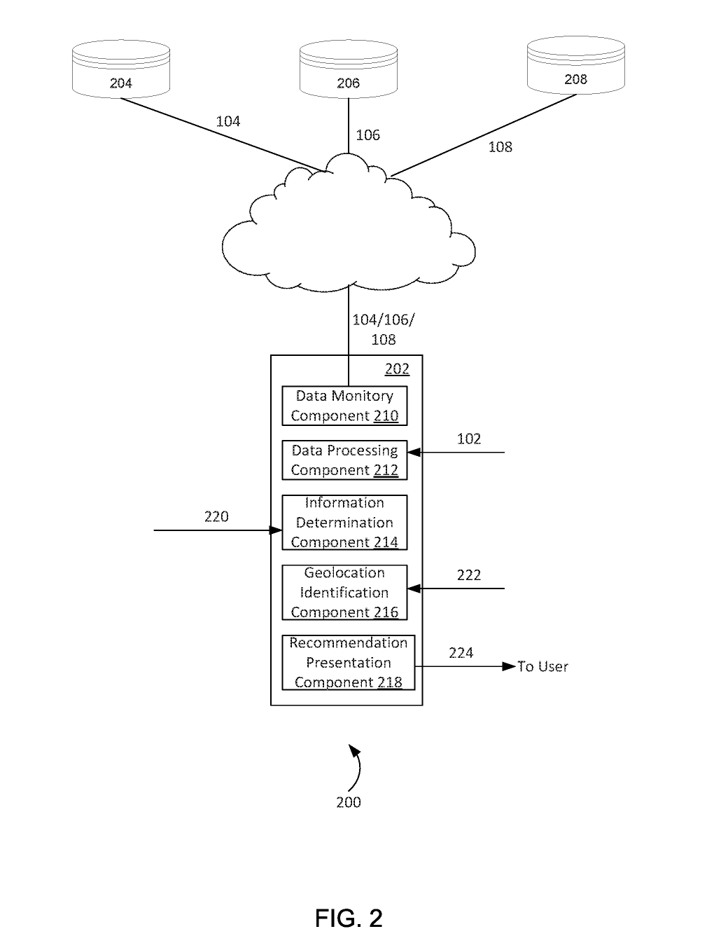

With the geolocation recommendation having been generally described in concept, attention is now directed to FIG. 2, where an exemplary recommendation system 200 is illustrated for implementing the geolocation recommendation in accordance with the disclosure. FIG. 2 will be described with reference to FIG. 1. As shown in this example, the recommendation system 200 can comprise one or more of a database/server 204, 206 and 208. As shown, the database/server 204 may be configured to provide social media data 104 as described above, the database/server 206 may be configured to provide planning data 106 as described above, the database/server 208 may be configured to provide corporate data 108 as described above. In some implementations, the database/server 204, 206, and/or 208 may be provided by corresponding third parties, such as a social media operator, a local government or a corporate. However, this is not necessarily the only case. In some implementations, the database/server 204, 206, and/or 208 may be provided and maintained by the same operator that operates the recommendation system 200.

In any case, the recommendation system 200 may comprise one or more of a processor configured to execute program components, which can include a data monitory component 210, a data processing component 212, an information determination component 214, a geolocation identification component 216, a recommendation presentation component 218, and/or any other components. The data monitory component 210 can be configured to monitor the database/servers 204, 206, 208, and/or any other databases or servers. Monitoring the database(s) and/or server(s) by the data monitory component 210 can include periodically or non-periodically inquiring new data provided by the database(s) or the server(s) since the last inquiry by the data monitory component 210. For example, the data monitory component 210 can be configured to periodically check latest postings by a set of users on a social media site. For instance, the set of users may be located in more or less the same geographical area as indicated by their location information listed on the social media site. This may involve automatically download those users' pages on the social media site, for example through a command or process like “http-get”. The data monitory component 210 may be configured to cache those pages in a storage associated with recommendation system 200. The cached pages may be compared with the latest downloaded user pages by the data monitory component 210 to determine any new data that has been posted by the users on their pages. As another example, the data monitory component 210 can be configured to check webpages of a city government—e.g., the municipality of San Diego and download and cache those webpages automatically. The data monitory component 210 can then determine any new data provided on those webpages by comparing the latest city webpages with previously cached webpages. A similar process can be performed for corporate webpages.

The data processing component 212 can be configured to process data 104, 106 and/or 108. The processing by the data processing component 212 can involve texting mining on data 104, 106, 108 and/or any other data. As described above, this may involve using one or more tokens 104 predefined by the operator(s) of the recommendation system 200. The text mining can involve extract phrases or sentences related to a particular token 104 and determining scores for the extracted phrases or sentences. For example, as illustration, the particular token 104 may specify “create job”, and the text mining performed by the data processing component 212 can involve extract phrases from data 104, 106, and/or 108 that contain “create jobs”, “job creation”, “add jobs”, or any other ngrams that are relevant to “create job”. The data processing component 212 can be configured to score those extract phrases or sentences by assigning a relevance score to them. For instance, an extracted sentence “by 2020, there will be 500 jobs created . . . ” may be assigned a higher relevance score than “although the project is three years away, mayor Brown indicated the project can create tremendous opportunities to the area and he expects the job growth rate after the project can be as high as 2%”.

In some implementations, the data processing component 212 may be configured to group or categorized the extracted phrases and/or sentences based on corresponding geolocations they are related to. For example, a set of extracted phrases related to geolocation #1 may be grouped together because these phrases were extracted by the data processing component 212 from pages of users located in geolocation #1 (e.g., as indicated by their current city information on those pages) on a social media site. As another example, a set of extracted sentences related to geolocation #2 may be grouped together because these sentences were extracted by the data processing component 212 from a news wire document announcing a new real-estate project at geolocation #2. In some implementations, the data processing component 212 may be configured to further group or categorize the extracted phrases and/or sentences based on the into a set of categorizes based on the contents of the extracted phrases and/or sentences. For example, for geolocation #1, a subset of extracted phrases may be formed because these phrases were extracted according to tokens “job create”, “new retailer move in”, “new resident move in”, “time to complete” and/or any other tokens. In some implementations, the data processing component 212 may be configured to group the extracted sentences and/or phrases based on their relevance scores. For example, the data processing component 212 can be configured to group the “job create” phrases with relevance scores above a certain threshold for geolocation #1.

The information determination component 214 can be configured to determining relevant information from the phrases and/or sentences processed by the data processing component 212 based on one or more rules 220. The rules 220 may be predefined by the operator(s) of the recommendation system 200 and may specify one or more conditions for determining the relevant information from the phrases and/or sentences. For example, as illustrations, a rule may be predefined for a real-estate project planned for geolocation #1. The rule may specify that job creation effects should be determined for all geolocations affected by this real-estate project. Based on this rule, the information determination component 214 can be configured to analyze extracted phrases as being relevant to the real-estate project in geolocation #1—for example, as determined by the data processing component 212 described above. The analysis may include extract a specific number or numbers from the phrases that may indicate or reflect the number of jobs that can be created by the real-estate project in geolocation #1.

In some implementations, a set of one or more rules may be used by the information determination component 214 to determine relevant information related to a project. For example, the rules may include a rule that specifies job creation effects, a rule that specifies a time length of the project, a rule that specifies specific roads that will be affected by the project, and/or any other rules. Using these rules, the information determination component 214 can analyze the extracted phrases and/or sentences as being related to the project and to determine such information as specified by the rules.

The geolocation identification component 216 can be configured to identify one or more geolocations for recommendation to user based on the information determined by the information determination component 214 based one or more criteria 222. As described above, the information determination component 214 may determine information for a particular geolocation based on data processed by the data processing component 212 using one or more rules 220. The determined information for the particular geolocation may indicate one or more projects may take place in the geolocation, their effects (such as a number of jobs that may be created by the project, a number of commercial entities may be affected by the project, a number of local residents may be affected by the project, a time period for the project) for each project in the geolocation. The one or more criteria may specify conditions for which the geolocation may satisfy for inclusion in a recommendation to the user.

For example, the criteria may include a condition indicating the geolocation must have at least 500 new jobs as indicated by the determined information, must have at least 30 new commercial entities after the project, the project must not take more than 3 years to complete in the geolocation and/or any other conditions in order for the geolocation to be included in the recommendation to the user. In some embodiments, the geolocation identification component 216 may be configured to assign a score to a particular geolocation based on the one or more criteria. For example, a score may be assigned to a first geolocation based on the first geolocation meeting the first criteria (e.g., will create a least 500 new jobs after the project is completed), meeting the second criteria (e.g., the project length to completion is 3 years), but failing the third criteria (e.g., less than 10, 000 new residents will move into the first geolocation after the project is completed. As another example, a different score may be assigned to a second geolocation based on the second geolocation meeting the second criteria but fail the first and the third criteria. In some implementations, the geolocation identification component 216 may be configure to identify the first geolocation for recommendation to user based on the score assigned to the first geolocation as described above has exceeded a threshold score; but not to identify the second geolocation for recommendation to user based on the score assigned to the second geolocation as described above is below the threshold score.

The recommendation presentation component 218 may be configured to generate a recommendation 224 for presentation to one or more users. The recommendation generated by the recommendation presentation component 218 may include information indicating a geolocation is identified as having good potential for growth based on recent project(s) planned for the geolocation. The recommendation may include information indicating job effects of the project(s) in the geolocation, time length for completion of each of the project(s), a number of commercial entities that may move into the geolocation after the completion of the project, a number of old infrastructure (e.g., factories, old houses) that may be torn down for the project, a number of new houses that will be built by the project, a number of new residents that may move into the geolocation, and/or any other relevant information that may aid the user to make a determination whether to invest in the geolocation. The presentation of the recommendation may vary in different applications. For example, it is contemplated that the recommendation 224 generated by the recommendation presentation component 218 may be presented via email, a webpage, or a text message to the user.

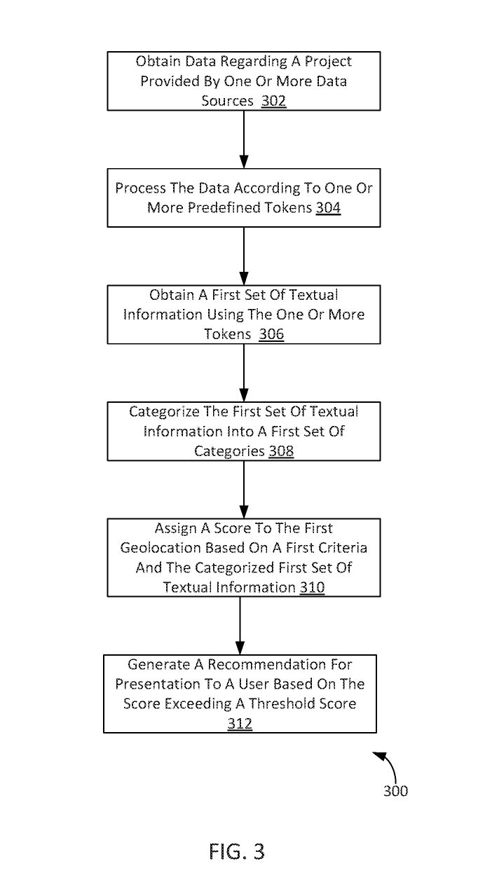

FIG. 3 illustrates an exemplary method for recommending one or more geolocations to a given user in accordance with the disclosure. The method presented in FIG. 3 and described below is intended to be illustrative and non-limiting. The particular series of processing steps depicted in FIG. 3 is not intended to be limiting. It is appreciated that the processing steps may be performed in an order different from that depicted in FIG. 3 and that not all the steps depicted in FIG. 3 need be performed.

In some embodiments, the method depicted in method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At 302, data regarding a project provided by one or more data sources can be obtained. As mentioned above, the data sources may include: social media outlets, city planning documents, corporate announcements and/or documents, and/or any other data sources. As described above, the data obtained at 302 may include unstructured data such as text information regarding one or more projects within a particular geographical location. In some exemplary implementations, operations involved in 302 may be implemented by data monitory component the same as or substantially similar to data monitory component 210 described and illustrated herein.

At 304, the data obtained at 302 can be processed using one or more predefined tokens. As described above, the predefined tokens obtained at 304 may include keywords regarding one or more projects or planning within the geographical location. Examples of the keywords may include the name of a particular geolocation (e.g., the city of San Diego, the city of New Port beach), “year”, “start date”, “job created”, “investment”, “money invested” and/or any other keywords. Those keywords or tokens can aid the text mining process performed by the recommendation system to find information relevant to the projects and/or planning within the one or more geographical locations. In some exemplary implementations, operations involved in 304 may be implemented by data processing component the same as or substantially similar to data processing component 212 described and illustrated herein.

At 306, a first set of textual information may be obtained from the processed data using the one or more tokens. This may involve text mining which can include extracting phrases or sentences related to a particular token and determining scores for the extracted phrases or sentences. For example, the first set of textual information may include phrases and/or sentences in the processed data related to a first token indicating a first geolocation. In some exemplary implementations, operations involved in 306 may be implemented by data processing component the same as or substantially similar to data processing component 212 described and illustrated herein.

At 308, the first of textual information can be categorized into a first set of categories. This may involve categorizing the phrases and/or sentences obtained at 308 into a first set of categorizes based on the contents of the extracted phrases and/or sentences. For example, for geolocation #1, a subset of extracted phrases may be formed because these phrases were extracted according to tokens “job create”, “new retailer move in”, “new resident move in”, “time to complete” and/or any other tokens. In some exemplary implementations, operations involved in 308 may be implemented by a data processing component the same as or substantially similar to data processing component 212 described and illustrated herein.

At 310, a score can be assigned to the first geolocation based on a first criteria and first categorized first set of textual information. The first criteria may specify conditions for which the geolocation may satisfy for inclusion in a recommendation to the user. For example, the criteria may include a condition indicating the geolocation must have at least 500 new jobs as indicated by the determined information, must have at least 30 new commercial entities after the project, the project must not take more than 3 years to complete in the geolocation and/or any other conditions in order for the geolocation to be included in the recommendation to the user. The score may be assigned to the first geolocation based on the one or more criteria. For example, the score may be assigned to the first geolocation based on the first geolocation meeting the first criteria (e.g., will create a least 500 new jobs after the project is completed), meeting the second criteria (e.g., the project length to completion is 3 years), but failing the third criteria (e.g., less than 10, 000 new residents will move into the first geolocation after the project is completed. Operations at 310 may involve identifying the first geolocation for recommendation to user based on the score assigned to the first geolocation as described above has exceeded a threshold score. In some exemplary implementations, operations involved in 310 may be implemented by geolocation identification component the same as or substantially similar to the geolocation identification component 216 described and illustrated herein.

At 312, a recommendation for presentation the user may be generated to include the first geolocation. The recommendation generated by the recommendation presentation component 218 may include information indicating the first geolocation is identified as having good potential for growth based on recent project(s) planned for the first geolocation. The recommendation may include information indicating job effects of the project(s) in the first geolocation, time length for completion of each of the project(s) in the first geolocation, a number of commercial entities that may move into the first geolocation after the completion of the project(s), a number of old infrastructure (e.g., factories, old houses) that may be torn down for the project(s) in the first geolocation, a number of new houses that will be built by the project(s) in the first geolocation, a number of new residents that may move into the first geolocation, and/or any other relevant information that may aid the user to make a determination whether to invest in the geolocation. The presentation of the recommendation may vary in different applications. For example, it is contemplated that the recommendation at 312 may be presented via email, a webpage, or a text message to the user. In some exemplary implementations, operations involved in 312 may be implemented by a recommendation component the same as or substantially similar to recommendation component 216 described and illustrated herein.

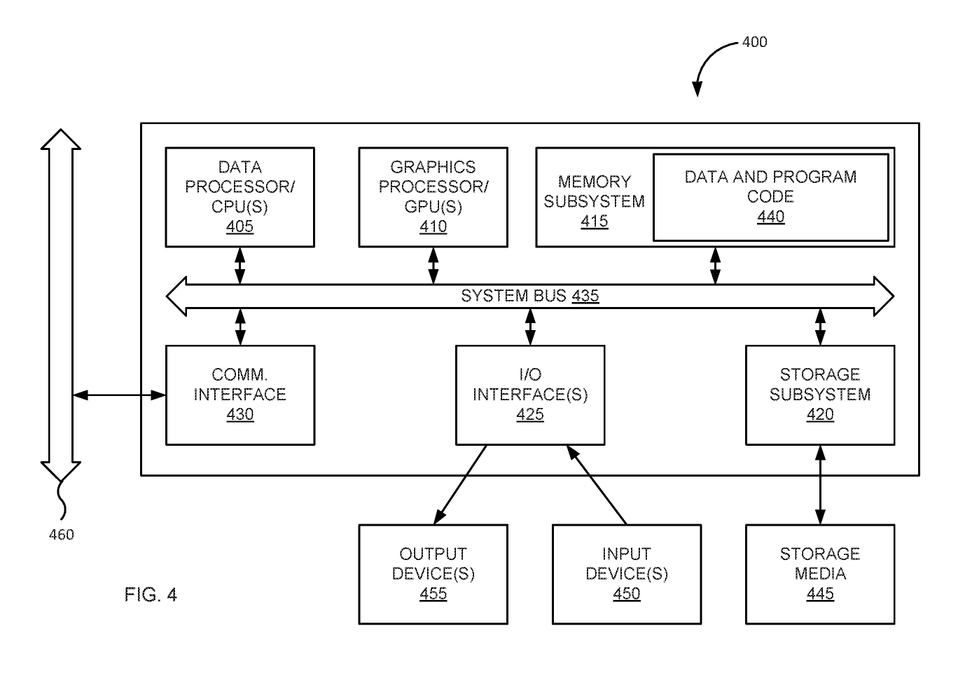

FIG. 4 is a block diagram of computer system 400 that can be used to implement various embodiments described and illustrated herein. FIG. 4 is merely illustrative. In some embodiments, a computer system includes a single computer apparatus, where the subsystems can be the components of the computer apparatus. In other embodiments, a computer system can include multiple computer apparatuses, each being a subsystem, with internal components. Computer system 400 and any of its components or subsystems can include hardware and/or software elements configured for performing methods described herein.

Computer system 400 may include familiar computer components, such as one or more one or more data processors or central processing units (CPUs) 405, one or more graphics processors or graphical processing units (GPUs) 410, memory subsystem 415, storage subsystem 420, one or more input/output (I/O) interfaces 425, communications interface 430, or the like. Computer system 400 can include system bus 435 interconnecting the above components and providing functionality, such connectivity and inter-device communication.

The one or more data processors or central processing units (CPUs) 405 can execute logic or program code or for providing application-specific functionality. Some examples of CPU(s) 405 can include one or more microprocessors (e.g., single core and multi-core) or micro-controllers, one or more field-gate programmable arrays (FPGAs), and application-specific integrated circuits (ASICs). As used herein, a processor includes a multi-core processor on a same integrated chip, or multiple processing units on a single circuit board or networked.

The one or more graphics processor or graphical processing units (GPUs) 410 can execute logic or program code associated with graphics or for providing graphics-specific functionality. GPUs 410 may include any conventional graphics processing unit, such as those provided by conventional video cards. In various embodiments, GPUs 410 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 410 may include any number of registers, logic units, arithmetic units, caches, memory interfaces, or the like.

Memory subsystem 415 can store information, e.g., using machine-readable articles, information storage devices, or computer-readable storage media. Some examples can include random access memories (RAM), read-only-memories (ROMS), volatile memories, non-volatile memories, and other semiconductor memories. Memory subsystem 415 can include data and program code 440.

Storage subsystem 420 can also store information using machine-readable articles, information storage devices, or computer-readable storage media. Storage subsystem 420 may store information using storage media 445. Some examples of storage media 445 used by storage subsystem 420 can include floppy disks, hard disks, optical storage media such as CD-ROMS, DVDs and bar codes, removable storage devices, networked storage devices, or the like. In some embodiments, all or part of data and program code 440 may be stored using storage subsystem 420.

The one or more input/output (I/O) interfaces 425 can perform I/O operations. One or more input devices 450 and/or one or more output devices 455 may be communicatively coupled to the one or more I/O interfaces 425. The one or more input devices 450 can receive information from one or more sources for computer system 400. Some examples of the one or more input devices 450 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 450 may allow a user of computer system 400 to interact with one or more non-graphical or graphical user interfaces to enter a comment, select objects, icons, text, user interface widgets, or other user interface elements that appear on a monitor/display device via a command, a click of a button, or the like.

The one or more output devices 455 can output information to one or more destinations for computer system 400. Some examples of the one or more output devices 455 can include a printer, a fax, a feedback device for a mouse or joystick, external storage systems, a monitor or other display device, a communications interface appropriately configured as a transceiver, or the like. The one or more output devices 455 may allow a user of computer system 400 to view objects, icons, text, user interface widgets, or other user interface elements. A display device or monitor may be used with computer system 400 and can include hardware and/or software elements configured for displaying information.

Communications interface 430 can perform communications operations, including sending and receiving data. Some examples of communications interface 430 may include a network communications interface (e.g. Ethernet, Wi-Fi, etc.). For example, communications interface 430 may be coupled to communications network/external bus 460, such as a computer network, a USB hub, or the like. A computer system can include a plurality of the same components or subsystems, e.g., connected together by communications interface 430 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

Computer system 400 may also include one or more applications (e.g., software components or functions) to be executed by a processor to execute, perform, or otherwise implement techniques disclosed herein. These applications may be embodied as data and program code 440. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 415 and/or storage subsystem 420.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method for generating a geolocation recommendation to a user, the method being implemented in a processor configured to execute machine-readable instructions, the method comprising:
obtaining data regarding a project provided by one or more data sources;
processing the data according to one or more predefined tokens, the predefined tokens including a first token indicating a first geolocation;
obtaining a first set of textual information using the first token, the first set of textual information containing information related to the first token;
categorizing the first set of textual information into a first set of categories;
assigning a score to the first geolocation based on a first criteria and the categorized first set of textual information; and
generating a recommendation for presentation to a user based on the score exceeding a threshold score.

2. The method of claim 1, wherein the one or more data sources includes a social media website, a database provided by a government entity, or a computing device associated with a corporate.

3. The method of claim 1, wherein the data includes information regarding a development within one or more geolocations including the first geolocation, and wherein the project relates to the development.

4. The method of claim 1, wherein the first set of categories includes a category for a job effect created by the project, a time length for completion of the project, a number of residents affected by the project, a number of entities affected by the project, a number of retailers will move into the first geolocation after the completion of the project, or a number of new residents will move into the first geolocation after the completion of the project.

5. The method of claim 1, wherein the first criteria specifies that a number of jobs created by the project must exceed a threshold number.

6. The method of claim 1, wherein the assignment of the score to the first geolocation is further based on a second criteria.

7. The method of claim 6, wherein the second criteria specifies the number of new retailers will move into the first geolocation after the completion of the project must exceed a threshold number.

8. The method of claim 1, further comprising effectuating the presentation of the recommendation to the user through an electronic mail, a text message and/or a webpage.

9. The method of claim 1, wherein the predefined tokens including a second token indicating a second geolocation, and wherein the method further comprises:
obtaining a second set of textual information using the second token, the second set of textual information containing information related to the second token;
categorizing the second set of textual information into the first set of categories;
assigning a score to the second geolocation based on the first criteria and the categorized second set of textual information; and
generating a recommendation for presentation to a user based on the score exceeding the threshold score.

10. A system for generating a geolocation recommendation to a user, the system comprising a processor configured to execute machine-readable instructions such that when the machine-readable instructions are executed, the processor is caused to perform:
obtaining data regarding a project provided by one or more data sources;
processing the data according to one or more predefined tokens, the predefined tokens including a first token indicating a first geolocation;
obtaining a first set of textual information using the first token, the first set of textual information containing information related to the first token;
categorizing the first set of textual information into a first set of categories;
assigning a score to the first geolocation based on a first criteria and the categorized first set of textual information; and
generating a recommendation for presentation to a user based on the score exceeding a threshold score.

11. The system of claim 10, wherein the one or more data sources includes a social media website, a database provided by a government entity, or a computing device associated with a corporate.

12. The system of claim 10, wherein the data includes information regarding a development within one or more geolocations including the first geolocation, and wherein the project relates to the development.

13. The system of claim 10, wherein the first set of categories includes a category for a job effect created by the project, a time length for completion of the project, a number of residents affected by the project, a number of entities affected by the project, a number of retailers will move into the first geolocation after the completion of the project, or a number of new residents will move into the first geolocation after the completion of the project.

14. The system of claim 10, wherein the first criteria specifies that a number of jobs created by the project must exceed a threshold number.

15. The system of claim 10, wherein the assignment of the score to the first geolocation is further based on a second criteria.

16. The method of claim 6, wherein the second criteria specifies the number of new retailers will move into the first geolocation after the completion of the project must exceed a threshold number.

17. The system of claim 10, wherein the processor is further caused to perform effectuating the presentation of the recommendation to the user through an electronic mail, a text message and/or a webpage.

18. The system of claim 10, wherein the predefined tokens including a second token indicating a second geolocation, and wherein the method further comprises:
obtaining a second set of textual information using the second token, the second set of textual information containing information related to the second token;
categorizing the second set of textual information into the first set of categories;
assigning a score to the second geolocation based on the first criteria and the categorized second set of textual information; and
generating a recommendation for presentation to a user based on the score exceeding the threshold score.
